(19) United States
(12) Patent Application Publication
(10) Pub. No.: US 2025/0055557 A1
(43) Pub. Date: Feb. 13, 2025

(54) SWITCHING BETWEEN A POLLING-BASED LOOKUP CONNECTION PROCESS AND AN INTERRUPT-BASED CONNECTION PROCESS

(71) Applicant: International Business Machines Corporation, Armonk, NY (US)

(72) Inventors: Gandhi Sivakumar, Bentleigh (AU); Kushal S. Patel, Pune (IN); Sarvesh S. Patel, Pune (IN)

(21) Appl. No.: 18/233,244

(22) Filed: Aug. 11, 2023

(51) Int. Cl. H04B 7/185; H04W 74/06; H04W 76/10

(52) U.S. Cl. CPC H04B 7/18513; H04W 74/06; H04W 76/10

(57) ABSTRACT

A computer-implemented method, according to one embodiment, includes generating a map of a first satellite's orbital path with respect to Earth's surface. The method further includes identifying, on the map along the first satellite's orbital path, a first portion of Earth's surface from which more than a predetermined number of connection requests are expected to be received. In response to a determination that a footprint coverage region of the first satellite is within a predetermined proximity to the first portion of Earth's surface, a connection processor of the first satellite is caused to perform a predetermined polling-based lookup connection process for fulfilling connection requests. A computer program product, according to another embodiment, includes a computer readable storage medium having program instructions embodied therewith. The program instructions are readable and/or executable by a computer to cause the computer to perform the foregoing method.

### BACKGROUND

The present invention relates to processing jobs of a workload, and more specifically, this invention relates to workload management based on switching between a polling-based lookup connection process and an interrupt-based connection process.

Communication networks typically include a plurality of communication devices that communicate with other communication devices via wireless signals. For example, communication devices may include, e.g., computers, cellular phones, fax machines, network enabled tablets, etc. These wireless signals are sometimes relayed via communication relay devices on Earth's surface, e.g., ground antennas, routers, modems, etc. In some cases, these wireless signals may additionally and/or alternatively be transmitted via connection requests that are output from communication devices to satellites.

Cloud providers, e.g., such as corporations, establish relationships with satellite companies in some cases in order to achieve two distinctly different objectives. For example, commercial satellite constellations generate relatively extensive amounts of data that needs to be stored, processed, and analyzed. This makes these satellite companies prime customers for the cloud providers. Meanwhile, the expansion of edge computing beyond traditional terrestrial network connections drives direct connections between data centers and satellite broadband ground stations to reduce latency and increase application speeds.

### SUMMARY

A computer-implemented method, according to one embodiment, includes generating a map of a first satellite's orbital path with respect to Earth's surface. The method further includes identifying, on the map along the first satellite's orbital path, a first portion of Earth's surface from which more than a predetermined number of connection requests are expected to be received. In response to a determination that a footprint coverage region of the first satellite is within a predetermined proximity to the first portion of Earth's surface, a connection processor of the first satellite is caused to perform a predetermined polling-based lookup connection process for fulfilling connection requests.

A computer program product, according to another embodiment, includes a computer readable storage medium having program instructions embodied therewith. The program instructions are readable and/or executable by a computer to cause the computer to perform the foregoing method.

A system, according to another embodiment, includes a processor, and logic integrated with the processor, executable by the processor, or integrated with and executable by the processor. The logic is configured to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2 is a flowchart of a method, in accordance with one embodiment of the present invention.

FIGS. 3A-3B are depictions of communication networks, in accordance with several embodiments of the present invention.

FIG. 4 is a LEO connection processor, in accordance with one embodiment of the present invention.

FIG. 5A is an environment, in accordance with one embodiment of the present invention.

FIG. 5B is an environment, in accordance with one embodiment of the present invention.

FIG. 6A is an environment, in accordance with one embodiment of the present invention.

FIG. 6B is an environment, in accordance with one embodiment of the present invention.

FIG. 7 is a dashboard, in accordance with one embodiment of the present invention.

FIG. 8 is a flowchart of a method, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for workload management based on switching between a polling-based lookup connection process and an interrupt-based connection process.

In one general embodiment, a computer-implemented method includes generating a map of a first satellite's orbital path with respect to Earth's surface. The method further includes identifying, on the map along the first satellite's orbital path, a first portion of Earth's surface from which more than a predetermined number of connection requests are expected to be received. In response to a determination that a footprint coverage region of the first satellite is within a predetermined proximity to the first portion of Earth's surface, a connection processor of the first satellite is caused to perform a predetermined polling-based lookup connection process for fulfilling connection requests.

In another general embodiment, a computer program product includes a computer readable storage medium having program instructions embodied therewith. The program instructions are readable and/or executable by a computer to cause the computer to perform the foregoing method.

In another general embodiment, a system includes a processor, and logic integrated with the processor, executable by the processor, or integrated with and executable by the processor. The logic is configured to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as workload management switch determination code of block 150 for workload management based on switching between a polling-based lookup connection process and an interrupt-based connection process. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

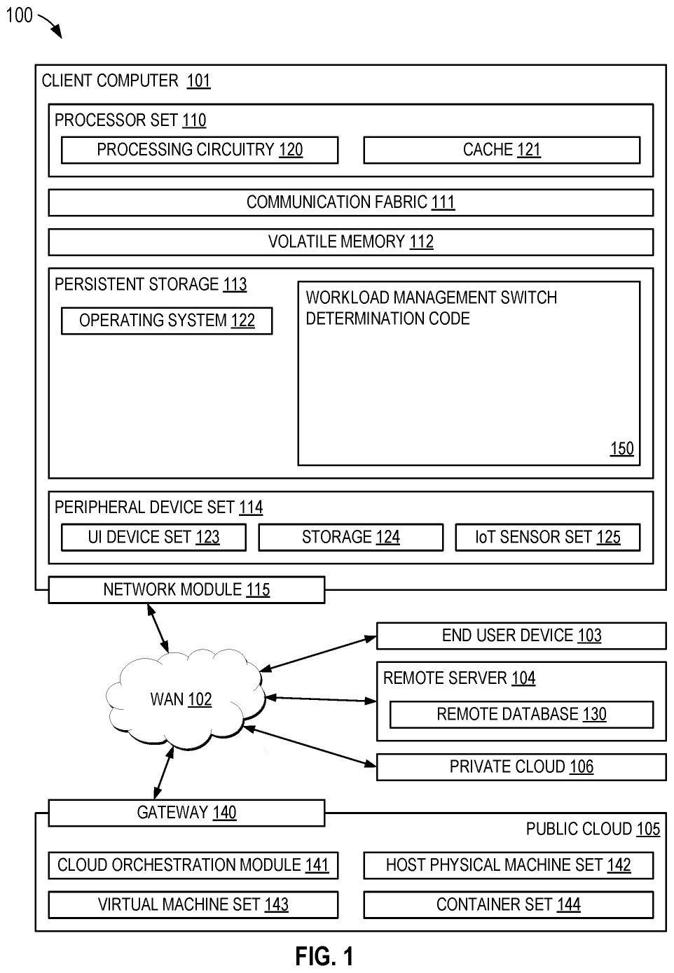

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

As mentioned elsewhere above, communication networks typically include a plurality of communication devices that communicate with other communication devices via wireless signals. For example, communication devices may include, e.g., computers, cellular phones, fax machines, network enabled tablets, etc. These wireless signals are sometimes relayed via communication relay devices on Earth's surface, e.g., ground antennas, routers, modems, etc. In some cases, these wireless signals may additionally and/or alternatively be transmitted via connection requests that are output from communication devices to satellites.

Cloud providers, e.g., such as corporations, establish relationships with satellite companies in some cases in order to achieve two distinctly different objectives. For example, commercial satellite constellations generate relatively extensive amounts of data that needs to be stored, processed, and analyzed. This makes these satellite companies prime customers for the cloud providers. Meanwhile, the expansion of edge computing beyond traditional terrestrial network connections drives direct connections between data centers and satellite broadband ground stations to reduce latency and increase application speeds.

Satellites typically orbit the Earth in order to assist in the communication networks, such as those described above. The altitude at which a satellite orbits the Earth may depend on the type and components of a satellite. For example, a low Earth orbit (LEO) is, as the name suggests, an orbit that is relatively close to the Earth's surface. For example, these orbits are typically performed at an altitude of less than 1000 kilometers (km) but may be as low as 160 km above the Earth's surface. This is relatively low compared to the orbits of other satellites, but still relatively very far above the Earth's surface. Because these LEO satellites orbit the earth at such relatively close distances, direct microwave transmission from user devices to one or more LEO satellites is possible. Unlike satellites in geostationary orbit (GEO) that must always orbit along the Earth's equator, LEO satellites do not always follow a particular path around the Earth in the same way. Rather a plane of an orbit may be tilted with respect to the equator, and therefore there are relatively more available routes for satellites in LEO.

LEO satellites are revolving around the Earth at relatively lower altitudes than geo-stationary satellites, and hence LEO satellites are not stationary with respect to Earth's movement. Because the movement of LEO satellites can be observed from Earth's surface, and LEO satellites are relatively much closer to Earth's surface than geo-stationary satellites, to maintain the rotation equilibrium, the speed of LEO satellites is a metric which relatively largely impacts the footprint region when LEO satellites are used for direct connection purposes. This also means that a footprint coverage region of a LEO satellite is fairly limited in that coverage timelines are relatively shorter proportional to a speed that the LEO's are orbiting Earth's surface. For this reason, multiple LEO satellites may be orbiting the plane which acts as a mesh to offer continuous coverage for a given area. As will be described in greater detail elsewhere below, LEO satellites in such a mesh can be caused and/or configured to communicate with one another via inter-satellite links which serve as a relatively high speed network line between the satellites.

Because LEO satellites orbit relatively close to Earth's surface, a footprint coverage region of a given LEO satellite with respect to earth is relatively more limited than a satellite that is otherwise orbiting Earth relatively further from Earth's surface. This means that a given LEO can serve a specific earth based region for a limited time duration which may range from between fifteen minutes to a few hours. This further means that remove connection events and handover events occur when edge devices are using LEO based connection processing. In case in which connections are created to a LEO satellite, e.g., from a user device on Earth's surface which may be an edge device, as the satellite is moving away from the user device's trajectory footprint region, the satellite performs a handoff and/or disconnect operation, and a new connection is eventually made between the user device and a different satellite serving the region. Because this connection disconnect and reconnect occurs relatively fast, application packet transmission is not affected, and the method is transparent to the user device. Additionally, in cases in which there are a relatively extensive number of requests that need to be transferred from a geo-location due to a LEO satellite moving away from a trajectory footprint, connections (DTCH) associated with these requests are disconnected from the first LEO satellite and all the respective user devices thereafter make connection attempts to a second LEO satellite. However, because there are multiple requests that occur at the same time, relatively more interrupts are caused, e.g., in order to accept the connection request and process them. On every DHCH connection request, when the connection request is received at a target, a kernel of the target device may perform a protocol that includes processing and decoding packet associated with the new connection request. Once the connection request is detected, the kernel thread may send the interrupt to a CPU for handling the new connection request.

In situations in which there are multiple requests made, relatively more interrupts are generated, which ultimately causes a slowdown of CPU user thread processing because the processor is forced to: handle the interrupt requests, process the packet data transmission, and process other threads running on the CPU. Polling is another technique used to establishing connections instead of performing interrupt driven approaches. However, there are disadvantages of polling based connection processing that include relatively more CPU cycles are performed, as well as a relatively increased turnaround time for creating a session based on polling delays being added in a total elapsed time for processing. Furthermore, in a polling-based approach, the polling thread may take relatively more time for certain sessions to complete because such sessions may be the first one received after the last polling cycle. Because of these limitations, polling based approaches are not conventionally used for satellite connection management because polling ultimately reduces transparency with respect to user applications. Accordingly, there is a longstanding need for techniques that enable management of having relatively many connection requests without causing interrupt overhead in a LEO satellite connection process.

In sharp contrast to the deficiencies of the conventional approaches described above, the techniques of embodiments and approaches described herein offer a processing capability based approach that dynamically switches between a polling-based lookup connection process and an interrupt-based connection process based on a context of that a LEO satellite, e.g., a geographical location of the LEO satellite, an extent of incoming connection requests, etc. It should be distinguished that there are no conventional techniques that selectively tune such connection processes, which is a key problem for LEO satellite based connections managers within 5G and 6G networks. In order to mitigate the deficiencies of the conventional techniques described above, the novel techniques described herein preferably work with a LEO satellite connection processor and dynamically handle connection request processing in the LEO to coordinate an effective connection request handing by switching between polling and interrupt driven approaches during a LEO connection handover. In some use cases, the process of these techniques may be run inside a kernel and user space of a connection processing module in the LEO satellite connection processor and locate the functions of interrupt and polling based lookup for incoming connection requests. By default, the interrupt driven approach is used where any new incoming request will be processed by the kernel thread. Once the protocol processing is completed for incoming requests, interrupt may be sent to establish a connection in a user device space of the operating system. Once the connection request handover occurs, further allocation decisions with respect to the system resources may be made, and connection success or failure messages may be sent to an initiator. The process further locates active connections on a device and locates relatively major handover requirements between LEO satellites. This occurs specifically when a given LEO satellite is crossing over a city area where there are a relatively extensive number of connections that need to be handed over to another region. The process further locates active connection processors, and then enquires an initiator geographical location to identify a handover requirement. Once the enquiry is performed for all LEO satellites, a space specific map, of the orbital coordinates from where the satellite will experience the handover and other LEO satellites will experience the connection requests, is generated.

Once the map is generated, information associated with the map is supplied to a threshold monitoring process. The threshold monitoring process preferably locates the current location of a given LEO satellite and maps the location against an activation time of a polling interval of the connection processing. A distance threshold may be derived from configuration parsing approaches and then the locations are tracked. In response to a determination that a LEO satellite reaches a predetermined boundary region where more connection requests are expected, a signal may be sent to a kernel based module of the connection processor to switch from a predetermined interrupt-based connection process for fulfilling connection requests to a predetermined polling-based lookup connection process for fulfilling connection requests. Because relatively more connection requests are expected to be initiated in this region, upon every polling cycle, new connections may be detected by the polling thread which reduces multiple interruptions that would otherwise be experienced for soft interrupt request (IRQ) processing. Once the polling thread has begun, on every predefined polling time interval, a proactive check may be performed for determining connection requests that have arrived at a kernel. Each of the determined connection requests may be processed accordingly. Because this will be a relatively busy time, it is likely that, whenever polling happens, new connections will be received and processed, and hence the polling cycles are thereby leveraged optimally. A monitoring process may be caused to collect statistics that detail how many polling cycles occur and the connections that are processed as part of a polling cycle to monitor the requirements of polling on the handover cases. Upon a predefined number of polling cycles occurring in which there are less than a predetermined threshold number of connections processed, the polling processing may be caused to be unloaded and a switch may be performed to start the default interrupt approach based on the assumption that most of the handover has occurred. This way, the default processing may continue to work for the other connection requests. As a result of dynamically switching between these two processes, performance benefits for the processing units are experienced during handover as well as during usual runtime.

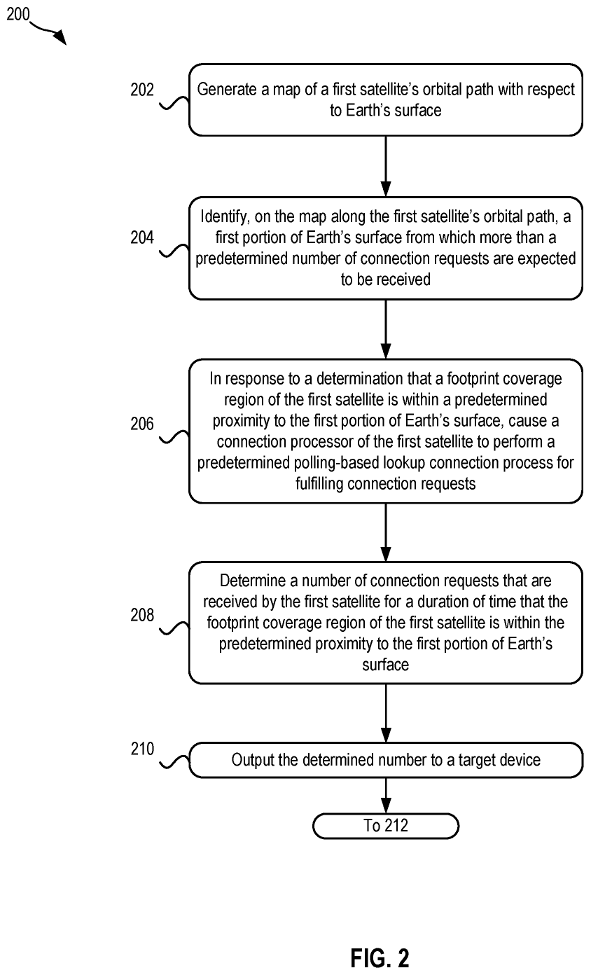

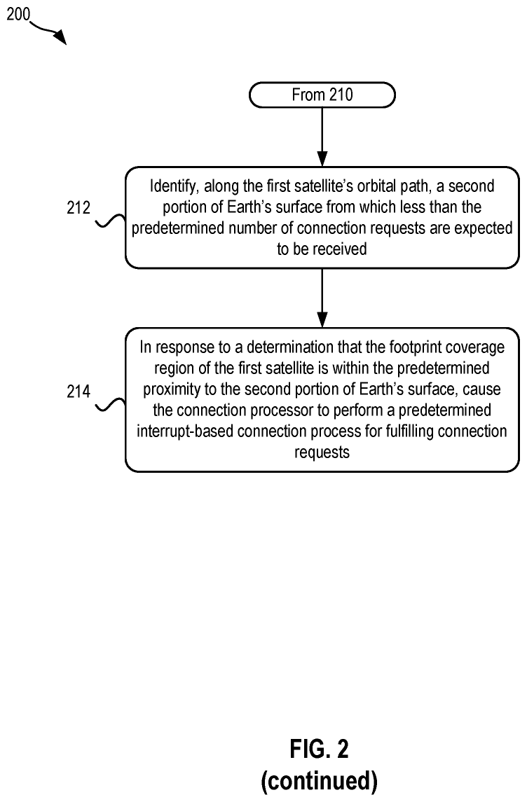

Now referring to FIG. 2, a flowchart of a method 200 is shown according to one embodiment. The method 200 may be performed in accordance with the present invention in any of the environments depicted in FIGS. 1-8, among others, in various embodiments. Of course, more or fewer operations than those specifically described in FIG. 2 may be included in method 200, as would be understood by one of skill in the art upon reading the present descriptions.

Each of the steps of the method 200 may be performed by any suitable component of the operating environment. For example, in various embodiments, the method 200 may be partially or entirely performed by a computer, or some other device having one or more processors therein. The processor, e.g., processing circuit(s), chip(s), and/or module(s) implemented in hardware and/or software, and preferably having at least one hardware component, may be utilized in any device to perform one or more steps of the method 200. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that method 200 may, in some preferred approaches, be performed by a device that is configured to process connection requests. In one or more of such approaches, the device is a kernel component of a LEO satellite. In some other approaches, operations of method 200 may be performed by a user device, e.g., such as a computer that is in communication with one or more satellites, which is on Earth's surface. In one or more of such approaches, the user device may have access to a direct power source and thereby be able to gather information and/or perform computations for the satellites and thereafter relay at least some of such information and/or computation results to one or more of the satellites.

Operation 202 includes generating a map of a first satellite's orbital path with respect to Earth's surface. In some approaches, the map of the first satellite's orbital path with respect to Earth's surface is a temporal mapping. It should be noted that although the operation(s) of some approaches herein are described to be performed with respect to a first satellite, in some approaches, the operations may additionally and/or alternatively be performed with respect to a plurality of satellites, e.g., the satellites that make up a mesh. In some preferred approaches, as least some of the satellites, and potentially up to all of the satellites are LEO satellites. The map may be generated and detail at least some of the satellites with respect to their orbit around Earth. For example, in some approaches, a temporal mapping of positions of a first satellite with respect to predetermined portions of Earth is generated. Depending on the approach, the predetermined portions of Earth may be, e.g., a location of a city determined to have more than a predetermined threshold of population, a city determined to have less than the predetermined threshold of population, a body of water, and a portion of land determined to be subject to connection signal interference, a predetermined portion of land that is associated with a paid service subscription for processing connection requests received from user devices located at the predetermined portion of land, etc.

In some approaches, in order to generate the map, method 200 may include initiating an instance for a proposed LEO eclipse identifier and movement arrangement. For example, upon instantiation of such an identifier and movement arrangement, data structures are loaded to a service instance, defined data collection resources are triggered to send data streams, and receiver data locations are identified and provisioned. These operations may, in some approaches, be performed using techniques that would become apparent to one of ordinary skill in the art after reading the descriptions herein. For context, the service instance may be made up of the pool of LEO satellite locations that can be used as temporary home for the connection processing. In some approaches, a list and a capacity of such instances may be decoded from configuration parsing approaches of a type that would become apparent to one of ordinary skill in the art after reading the descriptions herein. Furthermore, in some approaches, communication with the application storage instances may be made and a status may be enquired from target devices, e.g., user devices from which connection requests are received, user devices that relay connection a collection of user device connection requests, etc. Required resource capitals may additionally and/or alternatively be provisioned for the service as part of the process of generating the map. In some approaches, such provisioning may include using insertions to a predetermined softwarization management plane, and virtual network functions may be triggered to start the data transmission over a predetermined communication line. LEO satellite infrastructure application programming interface (API) instances may, in some approaches, be initiated, and handshaking of a type known in the art may be performed in the process of generating the map. For context, such operations may be further used to transmit the data requirement signal and recognition of event by the orchestration plane.

Information used to generate the map may additionally and/or alternatively be collected by invoking satellite infrastructure APIs to obtain physical parameters associated with the satellites that will be incorporated into the map. These physical parameters may include, e.g., a current altitude of a satellite, a trajectory of a satellite, orbital plane information of a satellite, an average moving speed of a satellite and/or eNodeBs of the satellite, an orbital path of a satellite, a shape of a satellite's orbital path, etc., a footprint region of a satellite, etc.

In some approaches, connection and/or disconnection functional information of the satellites may be collected and used for generating the map. For context, in some approaches, different satellites have different capabilities and constraints, and therefore may each have different operational timelines that can be expected for switching between connection processes. In order to determine such capabilities and constraints, in some approaches, the process begins within the kernel and a user space of a connection processing module of a LEO satellite connection processor. In some approaches, the kernel is caused, e.g., instructed, to locate functions of interrupt driven and polling based lookup for incoming connection requests. In some approaches, by default, the interrupt driven approach may be used where any new incoming connection request will be processed by the kernel thread. In some approaches, the determination of capabilities and constraints may check to determine whether at least a predetermined amount of operating system resources and/or space is available for processing connection requests. In response to a determination that the predetermined amount of operating system resources and/or space is not available for processing connection requests, the mapping does not incorporate the associated satellite. In contrast, in response to a determination that the predetermined amount of operating system resources and/or space is available for processing connection requests, the mapping is caused to incorporate the associated satellite. It should be noted that during an occurrence of a connection request handover to a user space process, further decisions may be made with respect to allocation of the system resources and whether connection success and/or failure messages will be sent to the initiator.

In some approaches, for at least a predetermined amount of time and/or until a predetermined threshold of information is collected, the map may be considered not generated. In other words, in some of such approaches, a sampling and trial period may be caused to be performed during which interaction between satellites and user device on Earth's surface is observed in order to determine portions of Earth's surface from which relatively more connection requests will be received. In some approaches, this sampling period additionally and/or alternatively includes locating active connections on the device and/or locates major handover requirements between two or more of the satellites in a predetermined mesh. For context, this step may be useful for determining whether other satellites will also have footprint coverage regions within the same portion of Earth's surface at the same time. In other words, method 200 may, in some approaches, the temporal details may be added to the map that detail that consider that an amount of connection requests may be distributed among a plurality satellites that have footprint coverage regions within the same portion of Earth's surface at the same time. These plurality satellites may be caused to distribute a total number of connection requests received from the same portion of Earth's surface, and thereby a number of connection requests that a given one of the satellites can be expected to accept and fulfill from that portion of Earth's surface may be relatively less than a number of connection requests that a lone satellite would be expected to accept while passing over that portion of Earth's surface.

Information obtained from the sampling and trial period may, in some approaches, be added to the map by dividing the map into a plurality of portions. The portion may be based on a predetermined division parameter, according to cities, according to a predetermined multiple of the footprint coverage region of a given one of the satellites, according to acres, according to square miles, public land and private land, portions of land and portions of water, etc. Associated information, which may be in the form of metadata, may, in some approaches, be added to of these portions for generating the map. Orbital paths of one or more of the satellites may, in some approaches, be overlayed over portions of the map in response to a determination that footprint coverage regions of the satellites pass over the portions of land.

Method 200 may additionally and/or alternatively include locating active connection processors and enquiring associated initiator geographical coordinate locations to identify handover requirements of the satellites. Techniques that would become apparent to one of ordinary skill in the art after reading the descriptions herein may be used. Once enquiries are performed for all the devices, at least some of the information detailed above may be used to generate the space specific map of the orbital coordinates from where the device will experience handovers and other device will experience connection requests may be generated in the map.

Operation 204 includes identifying, on the map along the first satellite's orbital path, a first portion of Earth's surface from which more than a predetermined number of connection requests, e.g., ten connection requests, one hundred connection requests, one thousand connection requests, one hundred thousand connection requests, etc., are expected to be received. In some approaches, more than a predetermined number of connection requests may be expected to be received from the first portion of Earth's surface in response to a determination, from the map, that the first portion of Earth's surface is a location that more than the predetermined number of connection requests have previously been received by the satellite or another satellite during a duration of time that the footprint coverage region of the first satellite is within a predetermined proximity to the first portion of Earth's surface.

In another approach, more than a predetermined number of connection requests may be expected to be received from the first portion of Earth's surface in response to a determination, from the map, that the first portion of Earth's surface is a location of a city determined to have a human population of at least a predetermined number of people. In another approach, more than a predetermined number of connection requests may be expected to be received from the first portion of Earth's surface in response to a determination that more than a predetermined number user device are, e.g., currently actually outputting connection requests at the first location, located at the first portion, located at the first portion more often than not located at the first portion, etc.

The footprint coverage region of the first satellite may come within a predetermined proximity to the first portion of Earth's surface, e.g., reaches boundary region where more connection requests are expected to be received, and thereafter cross over the first portion of Earth's surface while orbiting along the orbital path of the first satellite. While the footprint coverage region of the first satellite passes over the first portion of Earth's surface the first satellite may accept and fulfill connection requests received from user devices at the first portion of Earth's surface. Accordingly, in order to prepare for accepting such connection request, in response to a determination that the first satellite comes within the predetermined proximity to the first portion of Earth's surface the satellite may be caused to switch to a predetermined type of connection process that is predetermined to likely fulfill more than the predetermined number of connection requests with relatively less overhead than another predetermined type of connection process would. For example, in some preferred approaches, in response to a determination that a footprint coverage region of the first satellite is within a predetermined proximity to the first portion of Earth's surface, a connection processor of the first satellite is caused, e.g., instructed, to perform a predetermined polling-based lookup connection process for fulfilling connection requests, e.g., see operation 206. In some approaches, the instruction may be sent as a signal that is sent to a kernel based module of the connection processor of the first satellite to switch from an interrupt based processing to a polling driven approach. In some approaches, because a relatively extent of connection requests, e.g., more than a predetermined number of connection requests, are anticipated to be received in this region, upon every polling cycle, there may be new connections detected by the polling thread. Use of the polling driven approach as opposed to the interrupt based approach in such an approach reduces multiple interruptions to the Soft IRQ processing that would otherwise be experienced without deployment of various of the operations described herein.

The polling-based lookup connection process may be of a type of polling process described elsewhere herein and that would become apparent to one of ordinary skill in the art after reading the descriptions herein. In some approaches, the predetermined polling-based lookup connection process includes checking, on each predetermined time interval, for receipt of connection requests at a kernel of the first satellite. This way, at each interval, a batch of received connection requests that have been received since a most previous interval are processed together. The predetermined polling-based lookup connection process additionally includes processing the received connection requests, e.g., wherein the processing includes performing a handshake with the requesting user device and selectively granting connections to the requesting user devices to thereby enable fulfillment of the connection requests.

A number of connection requests that are received by the first satellite for a duration of time that the footprint coverage region of the first satellite is within the predetermined proximity to the first portion of Earth's surface, e.g., which may include being over the first portion of Earth's surface, may be determined, e.g., see operation 208. In some approaches, the connection requests are received by the first satellite while the footprint coverage region of the first satellite is over the first portion of Earth's surface. In some approaches, at least some of the connection requests are received by the first satellite while the footprint coverage region of the first satellite is not over the first portion of Earth's surface but is within the predetermined proximity to the first portion of Earth's surface. For context, this determined number may, in some approaches, be used to modify the map. For example, in response to a determination that at least the predetermined number of connection requests are not received during duration of time that the footprint coverage region of the first satellite is within the predetermined proximity to the first portion of Earth's surface, the first portion of Earth's surface may be modified in the mapping to be categorized as a portion of Earth's surface that less than the predetermined number of connection requests are expected to be received from. In some approaches, in response to such a modification in the map, the first satellite and/or another satellite may thereafter cause a connection processor to perform another connection process, e.g., other than the predetermined polling-based lookup connection process, for fulfilling connection requests in response to a determination that a footprint coverage region of the satellite is within a predetermined proximity to the first portion of Earth's surface.

Operation 210 includes outputting the determined number to a target device. The target device may include, another satellite, at least one device from which the connection requests are received during the duration of time that the footprint coverage region of the first satellite is within the predetermined proximity to the first portion of Earth's surface, a storage device that is accessible by one or more satellites, etc. The output determined number may, in some approaches, include an indication that the determined number corresponds to the first portion of Earth's surface. This information may, in some approaches, be used by another satellite to generate a map, e.g., a second map of a second satellite's orbital path with respect to Earth's surface.

Similar to how the first portion of Earth's surface from which more than the predetermined number of connection requests are expected to be received may be identified on the map, method 200 may additionally and/or alternatively include identifying, along the first satellite's orbital path, a second portion of Earth's surface from which less than the predetermined number of connection requests are expected to be received, e.g., see operation 212. In some approaches, the second portion of Earth's surface may be identified as being a location of Earth's surface that is a city determined to have less than the predetermined threshold of population, a body of water, a portion of land determined to be subject to connection signal interference, etc.

In response to a determination that the footprint coverage region of the first satellite is within the predetermined proximity to the second portion of Earth's surface, the connection processor is caused, e.g., instructed, to perform a predetermined interrupt-based connection process for fulfilling connection requests, e.g., see operation 214. The predetermined interrupt-based connection process for fulfilling connection requests may be of a type of interrupt process described elsewhere herein and that would become apparent to one of ordinary skill in the art after reading the descriptions herein.

In some approaches, the first portion of Earth's surface is proximate to the second portion of Earth's surface, e.g., such that upon exiting the first portion of Earth's surface headed in any direction, the first satellite enters the second portion based on the second portion surrounding the first portion and extending a predetermined distance from the first portion.

Although various approaches described above detail the use of the predetermined polling-based lookup connection process for fulfilling connection requests while the footprint coverage region of the first satellite is within the predetermined proximity to the first portion of Earth's surface, and the use of the predetermined interrupt-based connection process for fulfilling connection requests while the footprint coverage region of the first satellite is within the predetermined proximity to the second portion of Earth's surface, in some approaches, the method 200 incorporates non-location based dynamic switching between the connection processes. For example, in response to a determination that the predetermined number of connection requests are not received within a predetermined amount of time of the connection processor being caused to perform the predetermined polling-based lookup connection process, method 200 preferably includes causing the connection processor to switch to perform the predetermined interrupt-based connection process. For context, this switch may be applied on a case by case basis, and the method 200 may reconsider and/or revert to location based dynamic switching between the connection processes, e.g., in response to a predetermined amount of time passing, in response to a determination that the first satellite comes with the predetermined proximity to a next portion of Earth's surface, etc.

In some use cases, the first satellite may only have the computational resources to fulfill a portion of the connection requests received while the footprint coverage region of the first satellite is within the predetermined proximity to the first portion of Earth's surface and/or another portion of Earth's surface. Accordingly, method 200 may, in some approaches, include fulfilling a portion of the received connection requests and outputting an indication of the workload to other devices, e.g., such as other satellites that may also be available for fulfilling at least some of a remaining portion of the connection requests. For example, in some use cases, a plurality of connection requests may be received at the kernel of the first satellite. Method 200 may include selecting a first portion of the connection requests for the first satellite to fulfill. Such a selection is, in some approaches, based on available processing resources of the first satellite. An indication, e.g., connection request identifiers, identifiers of a user device associated with the connection request, etc., of the selected first portion of the connection requests may, in some approaches, be output to a target device that can use the information to base a workload off of and/or store the information for another satellite access. For example, in one of such approaches, the indication may be output to a second satellite determined have a footprint coverage region within the predetermined proximity to the first portion of Earth's surface to inform the second satellite of first portion of the connection requests that the first satellite is fulfilling.

The monitoring of the first satellite's location within the map, in some approaches, predetermined statistics may be collected for future reference and refinement. For example, in some approaches, statistics that detail how many polling cycles occur and the connections processed as part of polling cycle may be collected to monitor the requirement of polling on handover cases. In some approaches, in response to a determination that a predefined number of polling cycles have occurred in which less than a predetermined number of connections are processed, the processing may be unloaded via polling and the default interrupt approach may be stated based on an assumption that most of the handover has occurred. The default processing may continue to occur as usual thereafter, in some approaches.

Various performance benefits are enabled as a result of deploying the techniques described herein in a mesh of satellites for processing connection request. For example, these techniques enable dynamic sensing for the need of critical handovers between LEO satellites based on locations of the satellites. These handover determination and locations are based on collected input streams and autonomously provision an additional saving location for providing additional data security. Furthermore, these techniques include identifying the location, trajectory, and associated events to proactively tune the operations described herein. This refinement increases efficiency over time. Furthermore, these techniques effectively uses polling threads and avoids IRQ interruptions during handover, and leverages direct data connection to LEO eNodeBs during mass transition events. As a result, connection losses are avoided during mass transitions and balances workloads proactively to provide an uninterrupted service.

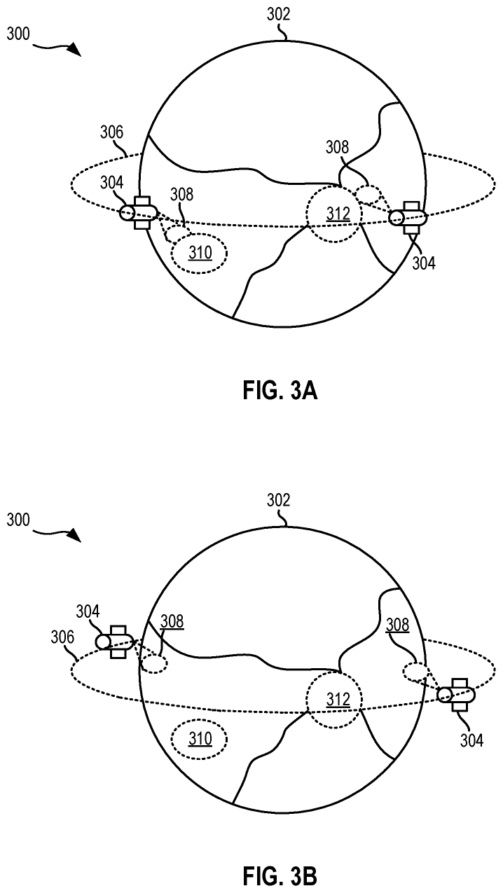

FIGS. 3A-3B depict communication network 300, in accordance with one embodiment. As an option, the present communication network 300 may be implemented in conjunction with features from any other embodiment listed herein, such as those described with reference to the other FIGS. Of course, however, such communication network 300 and others presented herein may be used in various applications and/or in permutations which may or may not be specifically described in the illustrative embodiments listed herein. Further, the communication network 300 presented herein may be used in any desired environment.

Referring first to FIG. 3A, communication network 300 is located around planet Earth 302. A first LEO satellite 304 orbits the Earth along an orbital path 306. A footprint coverage region 308 of the first satellite 304 changes as the first LEO satellite 304 orbits the Earth along an orbital path 306. For example, in FIG. 3A, the first LEO satellite 304 is shown in two different positions along orbital path 306. While traversing the orbital path 306, the footprint coverage region 308 of the first satellite 304 may be determined to be within a predetermined proximity to portions of the Earth's surface from which more than a predetermined number of connection requests are expected to be received, e.g., see portion 310 and portion 312. In response to such a determination, a connection processor of the first satellite may be caused to perform a predetermined polling-based lookup connection process for fulfilling connection requests.

However, referring now to the communication network 300 of FIG. 3B, the locations of the satellite have changed, and the footprint coverage region 308 of the first satellite 304 may be determined to not be within the predetermined proximity to portions 310 and 312 of the Earth's surface from which more than a predetermined number of connection requests are expected to be received. In response to such a determination, a connection processor of the first satellite may be caused to perform a predetermined interrupt-based connection process for fulfilling connection requests.

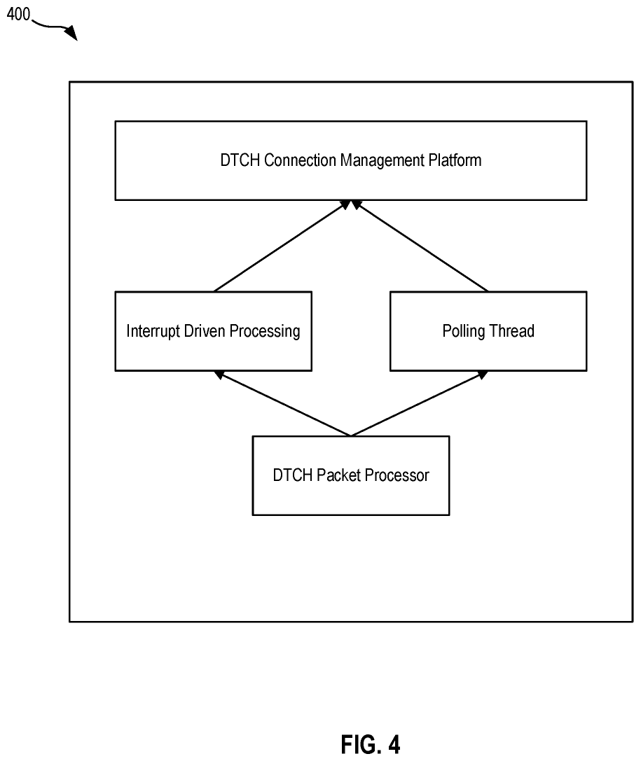

FIG. 4 depicts a LEO connection processor 400, in accordance with one embodiment. As an option, the present LEO connection processor 400 may be implemented in conjunction with features from any other embodiment listed herein, such as those described with reference to the other FIGS. Of course, however, such LEO connection processor 400 and others presented herein may be used in various applications and/or in permutations which may or may not be specifically described in the illustrative embodiments listed herein. Further, the LEO connection processor 400 presented herein may be used in any desired environment.

A plurality of sub-components that may be included in the LEO connection processor 400 are illustrated in FIG. 4. It should be noted that the LEO connection processor 400 may include additional or fewer components, depending on the approach.

With continued reference to FIG. 4, in some approaches, the LEO connection processor 400 may include a DTCH connection management platform that receives information from a DTCH packet processor. More specifically, in some approaches, the DTCH packet processor may issue interrupt driven processing information to the DTCH connection management platform as part of an interrupt-based connection process. In some other approaches, the DTCH packet processor may issue polling thread information to the DTCH connection management platform as part of a predetermined polling-based lookup connection process.

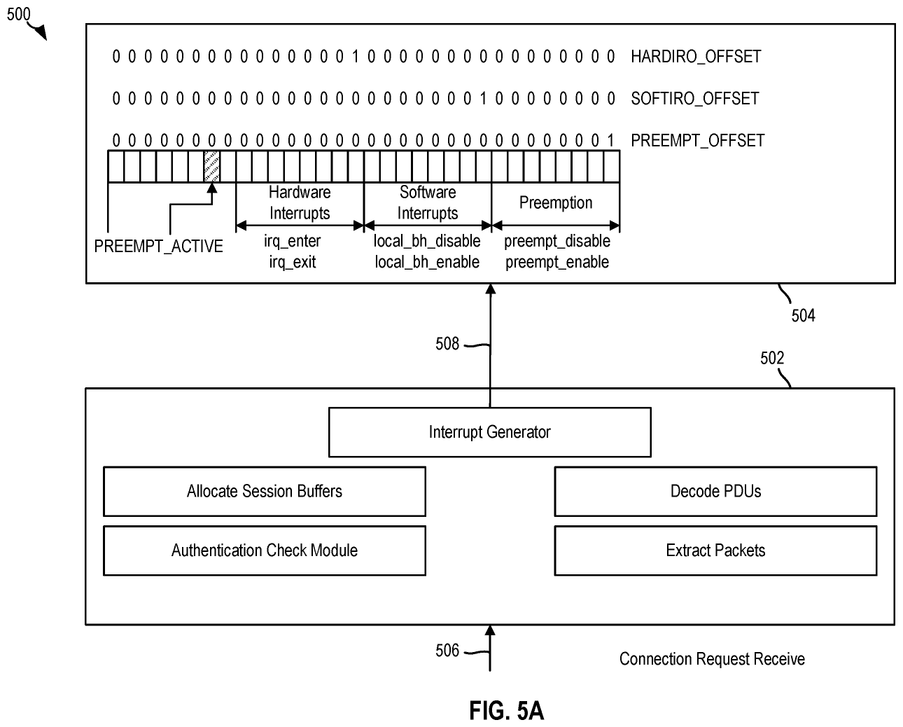

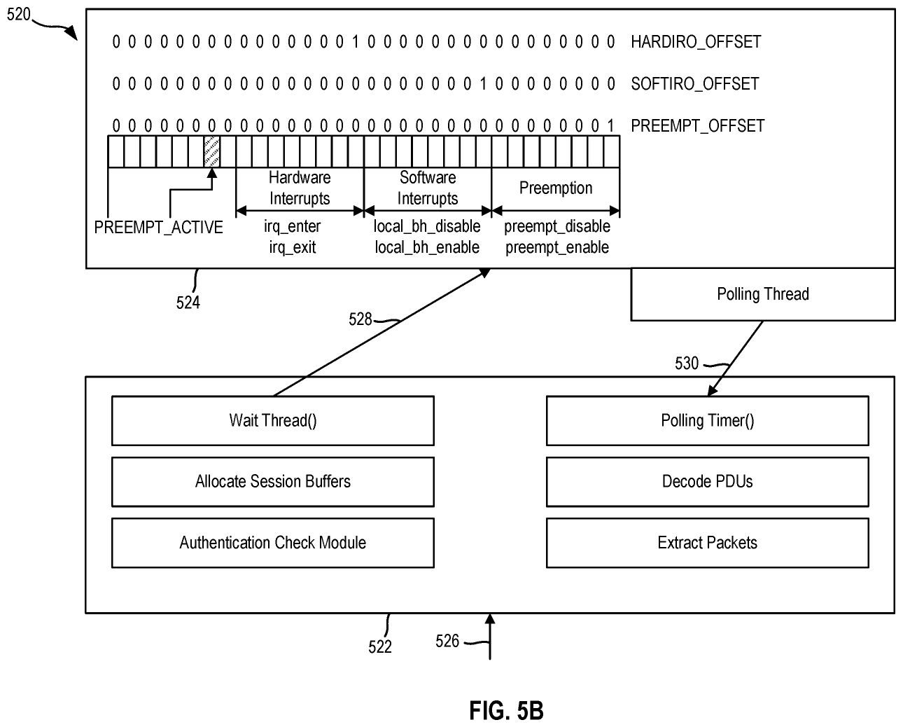

FIGS. 5A-5B depicts environments 500 and 520, in accordance with several embodiments. As an option, the present environments 500 and 520 may be implemented in conjunction with features from any other embodiment listed herein, such as those described with reference to the other FIGS. Of course, however, such environments 500 and 520 and others presented herein may be used in various applications and/or in permutations which may or may not be specifically described in the illustrative embodiments listed herein. Further, the environments 500 and 520 presented herein may be used in any desired environment.

Referring first to FIG. 5A, the environment 500 includes a kernel space 502 of a LEO satellite, and an IRQ-processing module 504 of the LEO satellite. A connection request may be received by the kernel space, e.g., see operation 506. The kernel space includes a plurality of components that may be used for processing the request. For example, in some approaches, the kernel space includes an authentication check component, allocation session buffers, decode PDUs, extract packets, and an interrupt generator.

In some approaches, in response to a determination that a footprint coverage region of the LEO satellite is within the predetermined proximity to a second portion of Earth's surface from which less than the predetermined number of connection requests are expected to be received, the kernel space may be caused to initiate performance of a predetermined interrupt-based connection process for fulfilling connection requests, e.g., see operation 508 issue a command to the IRQ-processing module 504.

Referring now to FIG. 5B, the environment 520 includes a kernel space 522 of a LEO satellite, and an IRQ-processing module 524 of the LEO satellite. A connection request may be received by the kernel space, e.g., see operation 526. The kernel space includes a plurality of components that may be used for processing the request. For example, in some approaches, the kernel space includes a wait thread component, allocation session buffers, an authentication check module, a polling threat timer, decode PDUs and an extract packets component.

In some approaches, in response to a determination that a footprint coverage region of the LEO satellite is within a predetermined proximity to a first portion of Earth's surface from which more than a predetermined number of connection requests are expected to be received, a connection processor of the kernel space is caused to initiate a predetermined polling-based lookup connection process for fulfilling connection requests. For example, a series of polling requests may be issued to the IRQ-processing module 524, e.g., see operation 528, and polling results determined by the IRQ-processing module 524 may be returned to the kernel space 522, e.g., see operation 530.

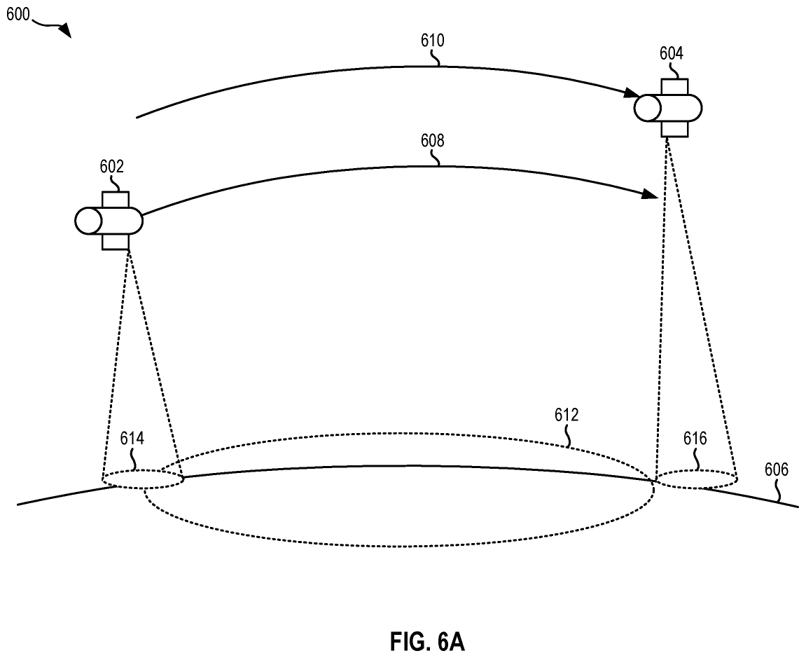

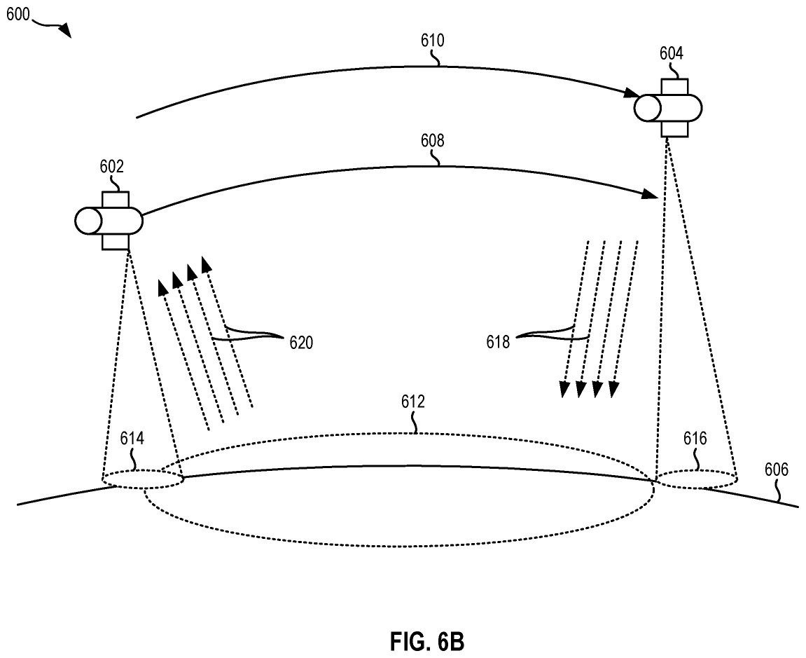

FIGS. 6A-6B depict environment 600, in accordance with several embodiments. As an option, the present environment 600 may be implemented in conjunction with features from any other embodiment listed herein, such as those described with reference to the other FIGS. Of course, however, such environment 600 and others presented herein may be used in various applications and/or in permutations which may or may not be specifically described in the illustrative embodiments listed herein. Further, the environment 600 presented herein may be used in any desired environment.

Referring first to FIG. 6A, the environment includes a first LEO satellite 602 orbiting Earth's surface 606 along a first orbital path 608 and a second LEO satellite 604 orbiting Earth's surface 606 along a second orbital path 610. In response to a determination that a footprint coverage region 614 of the first LEO satellite 602 is within a predetermined proximity to a first portion 612 of Earth's surface from which less than a predetermined number of connection requests are expected to be received, a connection processor of the first LEO satellite 602 is caused to perform a predetermined interrupt-based connection process for fulfilling connection requests. In contrast, as the second LEO satellite 604 exits coverage of the first portion 612 of Earth's surface, a footprint coverage region 616 of the second LEO satellite 604 may be determined to not be within a predetermined proximity to a first portion 612 of Earth's surface, and a determination may be made that the footprint coverage region 616 of the second LEO satellite 604 is within a predetermined proximity to a second portion of Earth's surface from which more than the predetermined number of connection requests are expected to be received. In response to these determinations, a connection processor of the second satellite is caused to perform a predetermined polling-based lookup connection process for fulfilling connection requests.

Referring now to FIG. 6B, the environment 600 includes a plurality of disconnect events 618, e.g., DTCH disconnect events, that are made by the second LEO satellite in response to a determination that the footprint coverage region 616 of the second first LEO satellite 604 is no longer within the predetermined proximity to the first portion 612 of Earth's surface. As a result of these disconnect events 618, user devices may reroute the connection requests to satellites having a footprint coverage region that is within the predetermined proximity to the first portion 612 of Earth's surface, e.g., see DTCH reconnect requests 620.

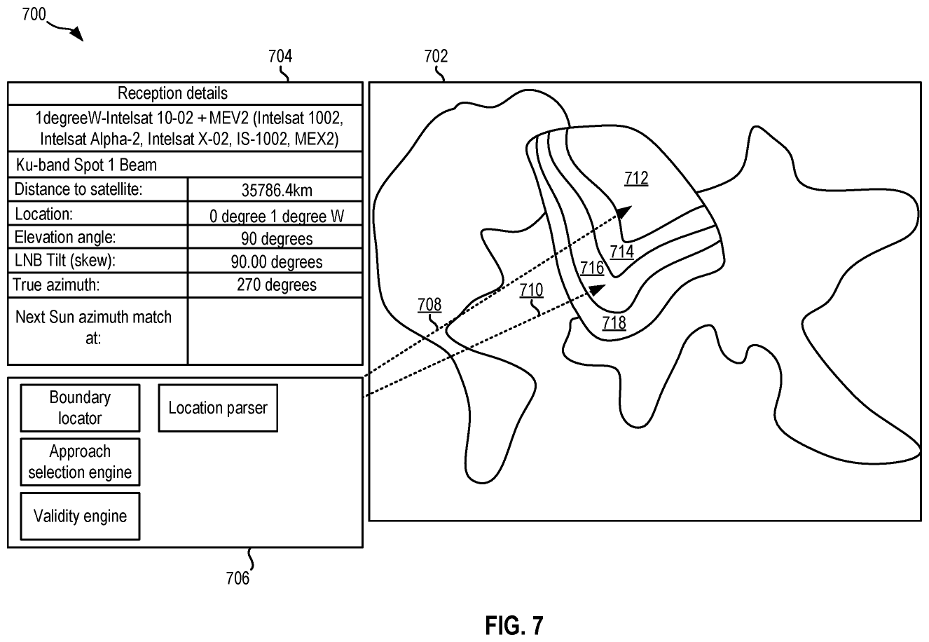

FIG. 7 depicts a dashboard 700, in accordance with one embodiment. As an option, the present dashboard 700 may be implemented in conjunction with features from any other embodiment listed herein, such as those described with reference to the other FIGS. Of course, however, such dashboard 700 and others presented herein may be used in various applications and/or in permutations which may or may not be specifically described in the illustrative embodiments listed herein. Further, the dashboard 700 presented herein may be used in any desired environment.

The dashboard 700 includes information that may be used to generating a map 702 of the orbital path(s) of one or more satellites with respect to Earth's surface. The dashboard includes reception details 704 with information detailing physical parameters of the one or more satellites. The dashboard 700 additionally includes a connection processing approach selector and actuator 706 that may be located on a processing circuit of a LEO satellite that may be used to generate the mapping, e.g., a location parser, a boundary locator, an approach selection engine for determining which connection process to perform, and a validity engine. The connection processing approach selector and actuator may be used to output interrupts 708 and/or polling threads 710 based on a determination that footprint coverage regions of satellites coming within a predetermined proximity to portions 712, 714, 716 and 718 of Earth's surface.

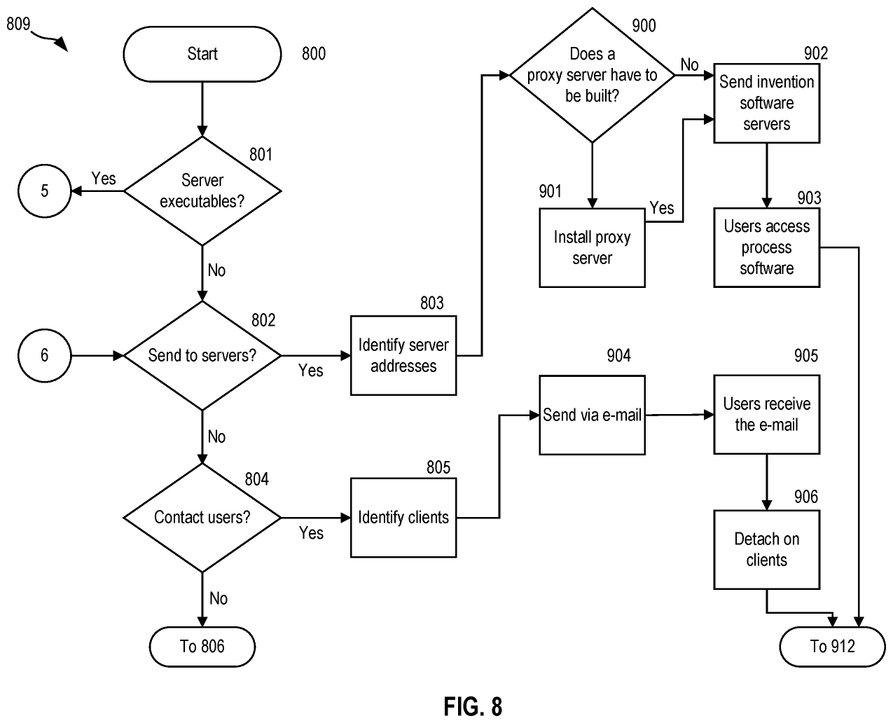

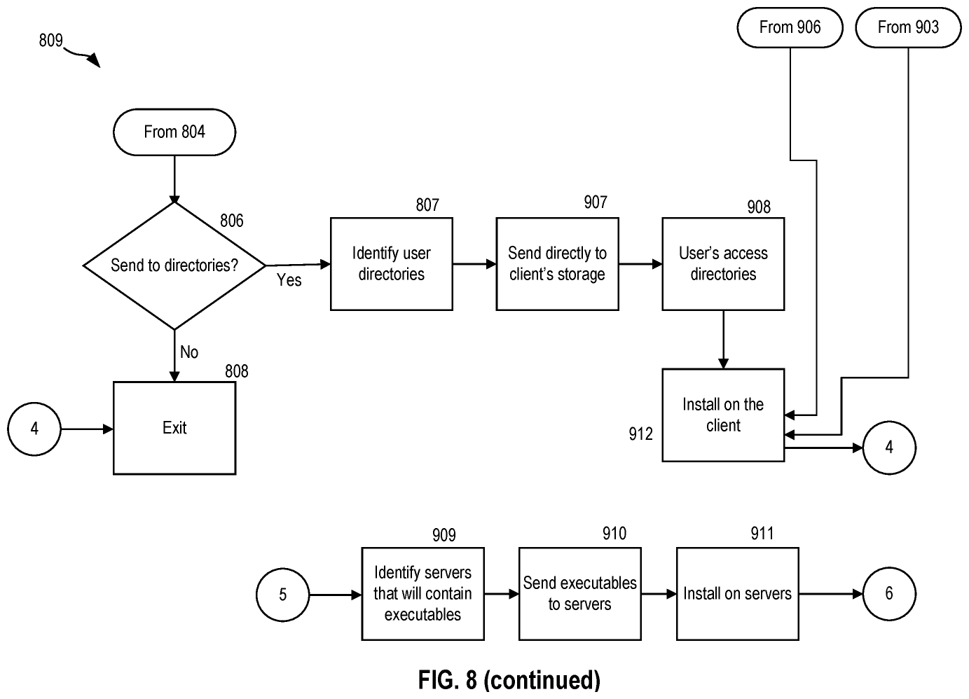

Now referring to FIG. 8, a flowchart of a method 809 is shown according to one embodiment. The method 809 may be performed in accordance with the present invention in any of the environments depicted in FIGS. 1-8, among others, in various embodiments. Of course, more or fewer operations than those specifically described in FIG. 8 may be included in method 809, as would be understood by one of skill in the art upon reading the present descriptions.

Each of the steps of the method 809 may be performed by any suitable component of the operating environment. For example, in various embodiments, the method 809 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 809. Illustrative processors include, but are not limited to, a central processing unit (CPU), an application specific integrated circuit (ASIC), a field programmable gate array (FPGA), etc., combinations thereof, or any other suitable computing device known in the art.

While it is understood that the process software for managing a workload based on switching between a polling-based lookup connection process and an interrupt-based connection process may be deployed by manually loading it directly in the client, server, and proxy computers via loading a storage medium such as a CD, DVD, etc., the process software may also be automatically or semi-automatically deployed into a computer system by sending the process software to a central server or a group of central servers. The process software is then downloaded into the client computers that will execute the process software. Alternatively, the process software is sent directly to the client system via e-mail. The process software is then either detached to a directory or loaded into a directory by executing a set of program instructions that detaches the process software into a directory. Another alternative is to send the process software directly to a directory on the client computer hard drive. When there are proxy servers, the process will select the proxy server code, determine on which computers to place the proxy servers' code, transmit the proxy server code, and then install the proxy server code on the proxy computer. The process software will be transmitted to the proxy server, and then it will be stored on the proxy server.

Step 800 begins the deployment of the process software. An initial step is to determine if there are any programs that will reside on a server or servers when the process software is executed (801). If this is the case, then the servers that will contain the executables are identified (909). The process software for the server or servers is transferred directly to the servers' storage via FTP or some other protocol or by copying though the use of a shared file system (910). The process software is then installed on the servers (911).

Next, a determination is made on whether the process software is to be deployed by having users access the process software on a server or servers (802). If the users are to access the process software on servers, then the server addresses that will store the process software are identified (803).

A determination is made if a proxy server is to be built (900) to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required, then the proxy server is installed (901). The process software is sent to the (one or more) servers either via a protocol such as FTP, or it is copied directly from the source files to the server files via file sharing (902). Another embodiment involves sending a transaction to the (one or more) servers that contained the process software, and have the server process the transaction and then receive and copy the process software to the server's file system. Once the process software is stored at the servers, the users via their client computers then access the process software on the servers and copy to their client computers file systems (903). Another embodiment is to have the servers automatically copy the process software to each client and then run the installation program for the process software at each client computer. The user executes the program that installs the process software on his client computer (912) and then exits the process (808).

In step 804 a determination is made whether the process software is to be deployed by sending the process software to users via e-mail. The set of users where the process software will be deployed are identified together with the addresses of the user client computers (805). The process software is sent via e-mail (904) to each of the users' client computers. The users then receive the e-mail (905) and then detach the process software from the e-mail to a directory on their client computers (906). The user executes the program that installs the process software on his client computer (912) and then exits the process (808).

Lastly, a determination is made on whether the process software will be sent directly to user directories on their client computers (806). If so, the user directories are identified (807). The process software is transferred directly to the user's client computer directory (907). This can be done in several ways such as, but not limited to, sharing the file system directories and then copying from the sender's file system to the recipient user's file system or, alternatively, using a transfer protocol such as File Transfer Protocol (FTP). The users access the directories on their client file systems in preparation for installing the process software (908). The user executes the program that installs the process software on his client computer (912) and then exits the process (808).

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
generating a map of a first satellite's orbital path with respect to Earth's surface;
identifying, on the map along the first satellite's orbital path, a first portion of Earth's surface from which more than a predetermined number of connection requests are expected to be received; and
in response to a determination that a footprint coverage region of the first satellite is within a predetermined proximity to the first portion of Earth's surface, causing a connection processor of the first satellite to perform a predetermined polling-based lookup connection process for fulfilling connection requests.

2. The computer-implemented method of claim 1, comprising:
identifying, along the first satellite's orbital path, a second portion of Earth's surface from which less than the predetermined number of connection requests are expected to be received; and
in response to a determination that the footprint coverage region of the first satellite is within the predetermined proximity to the second portion of Earth's surface, causing the connection processor to perform a predetermined interrupt-based connection process for fulfilling connection requests.

3. The computer-implemented method of claim 2, wherein the first portion of Earth's surface is proximate to the second portion of Earth's surface.

4. The computer-implemented method of claim 3, wherein the first portion of Earth's surface is a location of a city determined to have more than a predetermined threshold of population, wherein the second portion of Earth's surface is selected from the group consisting of: a city determined to have less than the predetermined threshold of population, a body of water, and a portion of land determined to be subject to connection signal interference.

5. The computer-implemented method of claim 1, wherein the first satellite is a low Earth orbit (LEO) satellite.

6. The computer-implemented method of claim 1, comprising: determining a number of connection requests that are received by the first satellite for a duration of time that the footprint coverage region of the first satellite is within the predetermined proximity to the first portion of Earth's surface; and outputting the determined number to a target device.

7. The computer-implemented method of claim 1, comprising: in response to a determination that the predetermined number of connection requests are not received within a predetermined amount of time of the connection processor being caused to perform the predetermined polling-based lookup connection process, causing the connection processor to switch to perform a predetermined interrupt-based connection process.

8. The computer-implemented method of claim 1, wherein the predetermined polling-based lookup connection process includes: checking, on each predetermined time interval, for receipt of connection requests at a kernel of the first satellite, and processing the received connection requests.

9. The computer-implemented method of claim 8, wherein a plurality of connection requests are received at the kernel of the first satellite, and comprising: selecting a first portion of the connection requests for the first satellite to fulfill; and outputting an indication of the selected first portion of the connection requests to a second satellite determined have a footprint coverage region within the predetermined proximity to the first portion of Earth's surface.

10. A computer program product, the computer program product comprising a computer readable storage medium having program instructions embodied therewith, the program instructions readable and/or executable by a computer to cause the computer to:
generate a map of a first satellite's orbital path with respect to Earth's surface;
identify, on the map along the first satellite's orbital path, a first portion of Earth's surface from which more than a predetermined number of connection requests are expected to be received; and
in response to a determination that a footprint coverage region of the first satellite is within a predetermined proximity to the first portion of Earth's surface, cause a connection processor of the first satellite to perform a predetermined polling-based lookup connection process for fulfilling connection requests.

11. The computer program product of claim 10, the program instructions readable and/or executable by the computer to cause the computer to:
identify, along the first satellite's orbital path, a second portion of Earth's surface from which less than the predetermined number of connection requests are expected to be received; and
in response to a determination that the footprint coverage region of the first satellite is within the predetermined proximity to the second portion of Earth's surface, cause the connection processor to perform a predetermined interrupt-based connection process for fulfilling connection requests.

12. The computer program product of claim 11, wherein the first portion of Earth's surface is proximate to the second portion of Earth's surface.

13. The computer program product of claim 12, wherein the first portion of Earth's surface is a location of a city determined to have more than a predetermined threshold of population, wherein the second portion of Earth's surface is selected from the group consisting of: a city determined to have less than the predetermined threshold of population, a body of water, and a portion of land determined to be subject to connection signal interference.

14. The computer program product of claim 10, wherein the first satellite is a low Earth orbit (LEO) satellite.

15. The computer program product of claim 10, the program instructions readable and/or executable by the computer to cause the computer to: determine a number of connection requests that are received by the first satellite for a duration of time that the footprint coverage region of the first satellite is within the predetermined proximity to the first portion of Earth's surface; and output the determined number to a target device.

16. The computer program product of claim 10, the program instructions readable and/or executable by the computer to cause the computer to: in response to a determination that the predetermined number of connection requests are not received within a predetermined amount of time of the connection processor being caused to perform the predetermined polling-based lookup connection process, cause the connection processor to switch to perform a predetermined interrupt-based connection process.

17. The computer program product of claim 10, wherein the predetermined polling-based lookup connection process includes: checking, on each predetermined time interval, for receipt of connection requests at a kernel of the first satellite, and processing the received connection requests.

18. The computer program product of claim 17, wherein a plurality of connection requests are received at the kernel of the first satellite, and the program instructions readable and/or executable by the computer to cause the computer to: select a first portion of the connection requests for the first satellite to fulfill; and output an indication of the selected first portion of the connection requests to a second satellite determined have a footprint coverage region within the predetermined proximity to the first portion of Earth's surface.

19. A system, comprising:
a processor; and
logic integrated with the processor, executable by the processor, or integrated with and executable by the processor, the logic being configured to:
generate a map of a first satellite's orbital path with respect to Earth's surface;
identify, on the map along the first satellite's orbital path, a first portion of Earth's surface from which more than a predetermined number of connection requests are expected to be received; and
in response to a determination that a footprint coverage region of the first satellite is within a predetermined proximity to the first portion of Earth's surface, cause a connection processor of the first satellite to perform a predetermined polling-based lookup connection process for fulfilling connection requests.

20. The system of claim 19, the logic being configured to:
identify, along the first satellite's orbital path, a second portion of Earth's surface from which less than the predetermined number of connection requests are expected to be received; and
in response to a determination that the footprint coverage region of the first satellite is within the predetermined proximity to the second portion of Earth's surface, cause the connection processor to perform a predetermined interrupt-based connection process for fulfilling connection requests.
